(19) United States
(12) Patent Application Publication
(10) Pub. No.: US 2011/0113905 A1
(43) Pub. Date: May 19, 2011

(54) LUBRICATING UNIT FOR A THREADED DRIVE UNIT

(76) Inventors: Paul Dietz, Guentersleben (DE); Andre Ziegler, Sand Am Main (DE)

(21) Appl. No.: 12/943,706

(22) Filed: Nov. 10, 2010

(30) Foreign Application Priority Data
Nov. 13, 2009 (DE) 10 2009 053 099.1

(51) Int. Cl. F16N 7/00; F16H 25/20

(52) U.S. Cl. 74/89.44

(57) ABSTRACT

A lubricating unit (20) for use with a threaded unit drive (10), composed of a spindle (12) extending in a longitudinal direction (11) and a nut (14) enclosing the spindle (12), includes a hollow-cylindrical housing (30) that has a base body (31) with an annular cavity (32) closed on the end face using a separate cover (36). A storage slab (70) composed of foam material is accommodated in the cavity (32) and is bent to form a ring. At least one oil-filling recess (79) extends through the storage slab (70). Fastening means (23) are provided on the longitudinal end face of the housing (30) opposite the cover (36) for fastening the housing (30) to the nut (14). The cover (36) is connected in an adhesive manner to the base body (31). At least one oil-filling opening (37) open toward the oil-filling recess (79) is provided in the housing (30).

### CROSS-REFERENCE

The invention described and claimed hereinbelow is also described in DE 102009053099.1, filed Nov. 13, 2009. This German Patent Application, whose subject matter is incorporated here by reference, provides the basis for a claim of priority of invention under 35 U.S.C. 119 (a)-(d).

### BACKGROUND OF THE INVENTION

The invention relates to a lubricating unit for use with a threaded drive unit.

A lubricating unit is made known in DE 10 2007 034 452 A1. According to FIG. 3 in DE 10 2007 034 452 A1, lubricating unit 10 is provided for use with a threaded drive unit. The threaded drive unit comprises a spindle 52 which extends in a longitudinal direction and is provided with thread turns 58, the spindle being enclosed by a nut 50. The lubricating unit comprises a hollow-cylindrical housing composed of a base body 14 and a cover 18 disposed on an end face of the base body. On the end face of the housing opposite the cover, fastening means are provided that can be used to fasten the lubricating unit to the nut. The fastening means comprise latch hooks 42 and a clamping nut 46.

The cover closes an annular cavity 16 in the interior of the housing. A storage slab 12 is accommodated in the cavity, and is depicted in greater detail in FIG. 4 of DE 10 2007 034 452 A1. The storage slab is substantially rectangular in design, and can contact the thread turn of the spindle via a bent projection 34. The storage slab is composed of an open-cell foam material, thereby enabling it to absorb and store lubricating oil. To enable the storage slab to be lubricated, it is provided with a large number of oil-filling recesses 38 that extend through the storage slab. For lubrication, first the annular cavity of the housing is filled partially with lubricating oil. Next, the non-lubricated storage slab is slid partially into the housing, and the lubricating oil is displaced into the oil-filling recesses. The storage slab then absorbs the lubricating oil until it is saturated with lubricating oil. It should be noted that this process takes a great deal of time. This is due to the fact that the pore structure of the foam material is optimized such that the lubricating oil is dispensed relatively slowly. Conversely, the foam material therefore absorbs the lubricating oil slowly. The storage slab cannot be slid entirely into the cavity of the housing until the foam has been fully saturated with lubricating oil, because the lubricating unit is filled with the largest possible quantity of lubricating oil. Next, the cover is fixedly connected to the base body.

The cover must be connected to the base body in the most fluid-tight manner possible to ensure that the lubricating unit does not leak during operation. Possible cost-effective connections include, in particular, connecting methods based on adhesive force, such as welding or bonding, since they can typically be designed to be fluid-tight. It has been shown that the aforementioned methods cannot be applied with the oil-filled lubricating unit since it cannot be reliably ruled out that the connecting point is wetted with lubricating oil that originates from the cavity or storage slab. However, an oil film prevents the base body and the cover from being connected in a manner based on adhesive force. In the case of the known lubricating unit, it must even be assumed that the cover and the base body will not become fixedly connected at all.

### SUMMARY OF THE INVENTION

The problem addressed by the invention is that of providing a lubricating unit, in the case of which the cover can be connected reliably and in a fluid-tight manner to the base body. To solve the problem, in the case of the lubricating unit according to the invention, the cover is bonded to the base body, wherein at least one oil-filling opening which is open toward the oil-filling recess is provided in the housing. The housing can be filled with lubricating oil through the oil-filling opening after the cover has been connected to the base body by adhesive force, in particular having been welded or bonded thereto. It is thereby reliably ensured that an oil film is not present in the region of the connecting point during the joining procedure. Since the oil-filling openings are opposite the oil-filling recesses, the lubricating oil can be filled into the oil-filling recesses in a short period of time. This lubricating oil is slowly absorbed by the storage slab during the inevitable storage periods, without the need to apply any special effort therefor. It should be noted that it is not possible to inject lubricating oil directly into the storage slab e.g. using a medical syringe. Since the oil diffusion occurs very slowly, this process would take so much time that the lubricating unit could not be manufactured cost-effectively.

According to a preferred lubricating unit, the oil-filling opening is provided in the cover, and the oil-filling recess is open toward the edge of the storage slab facing the cover. Most preferably, the base body and the cover are injection-molded out of plastic. The proposed oil-filling opening can be manufactured considerably easier in the cover than in the base body since the related injection-molding tool is much simpler in design. In particular, there is no need to provide an additional bar for the oil-filling opening in the injection-molding tool. Moreover, the end-face oil-filling openings in the cover can be closed using a longitudinal seal that is present anyway, thereby preventing lubricating oil from escaping through the oil-filling opening.

According to a preferred lubricating unit, the oil-filling recess is substantially T-shaped in design. The T-shape makes it possible to provide an oil-filling recess having a large volume. At the same time, the oil-filling recess is designed to be very narrow in the region of the oil-filling opening, and therefore only a small quantity of fluid is present directly at the oil-filling opening. Thus, there is no risk that a noteworthy quantity of lubricating oil will escape from the lubricating unit through the oil-filling opening. Moreover, the boundary surface of the T-shaped oil-filling recess on the storage slab is particularly large, and therefore the lubricating oil is absorbed relatively quickly into the storage slab.

According to a preferred lubricating unit, the storage slab is substantially rectangular in design and has an elongate projection that extends beyond the outline of the storage slab with a thickness that is unchanged relative to the rest of the storage slab, the elongate projection being bent by approximately 90°, thereby enabling it to contact a thread turn of the spindle. A storage slab of that type can be easily cut out of a prefabricated foam material plate using water-jet cutting without the need for any special reworking. The elongate shape makes it possible to easily bend the projection without having to reduce its thickness compared to the thickness of the storage slab. Due to the contact between the projection and the spindle, lubricant stored in the foam material can be transferred to the spindle. An open-cell foam material composed of polyurethane has proven suitable for this purpose.

According to a further preferred lubricating unit, at least one slot extends through the storage slab, being disposed in the extension of the elongate projection, wherein the bend of the projection is disposed in the region of the slot. This measure minimizes the amount of trimmings left over when the storage slab is cut out of a foam plate since the overhang of the elongate projection beyond the rectangular outline of the storage slab can be designed to be small. The extent of the aforementioned overhang determines the size of the non-usable surface area of the foam plate. The elongate shape of the projection is thus defined by the length of the slot and the size of the overhang. Due to the design, the bend of the projection is situated in the base region of the projection i.e. in the region in which the slot is likewise disposed. The aforementioned slot can basically have any width in order to perform its function. Nevertheless, the aim is for the width of the slot to be as small as possible to ensure that the storage volume of the storage slab is as great as possible.

According to a preferred lubricating unit, the fastening means include an external thread on the housing, onto which a clamping nut having an internal thread is screwed, wherein a fixing projection is provided on the housing, which can engage in a large number of recesses provided in the clamping nut. The purpose of the detent engagement of the fixing projection into the recesses is to prevent the clamping nut from accidentally rotating relative to the external thread. The lubricating unit would come loose from the nut as a result. The rotation lock that is provided can be manufactured easily using a plastic injection-molding procedure.

According to a further preferred lubricating unit, the recesses are elongate in design, are oriented in the longitudinal direction, and intersect the internal thread of the clamping nut. The rotation lock of the clamping nut is therefore particularly space-saving. The external thread is preferably a fine-pitch thread to minimize interference by the recesses on the threaded engagement. It should be noted that, in this embodiment, the fixing projection is disposed in the region of the external thread on the housing so that it can engage in the recesses.

According to a preferred lubricating unit, the fastening means comprise a large number of hooks that engage in a ring that is provided with an opening, wherein a locking body is disposed in the region of the opening in a manner such that the width of the opening in the circumferential direction of the ring cannot be substantially reduced. Fastening a lubricating unit to a nut using a large number of hooks that engage in an interrupted ring is known from DE 10 2006 033 852 A1. The aforementioned opening is necessary so that the ring can be snapped into the substantially rigid nut. The disadvantage of the known ring is that the snap-in connection between the ring and the nut can come loose when the clamping nut is tightened using excessive torque. This problem is prevented by the locking body since it counteracts a reduction of the diameter of the ring.

The locking body is preferably a ball since it can be clamped in the opening particularly easily.

According to a particularly preferred lubricating unit, the ring is provided with a radial projection that can engage in a matching recess in the nut.

The purpose of the radial projection is to prevent the ring from rotating relative to the nut. This embodiment is particularly advantageous in conjunction with the above-mentioned locking body since the locking body also causes the radial projection to disengage from the assigned recess.

### BRIEF DESCRIPTION OF THE DRAWINGS

The invention is explained below in greater detail with reference to the attached drawings. In the drawings:

FIG. 1 shows a perspective exploded view of a threaded drive unit having a lubricating unit according to the invention;

FIG. 2 shows a perspective view of the bent storage slab of the lubricating unit depicted in FIG. 1;

FIG. 3 shows a perspective exploded view of a second embodiment of the housing and the clamping nut; and

FIG. 4 shows a front view of the ring with the locking body.

### DETAILED DESCRIPTION OF THE PREFERRED EMBODIMENTS

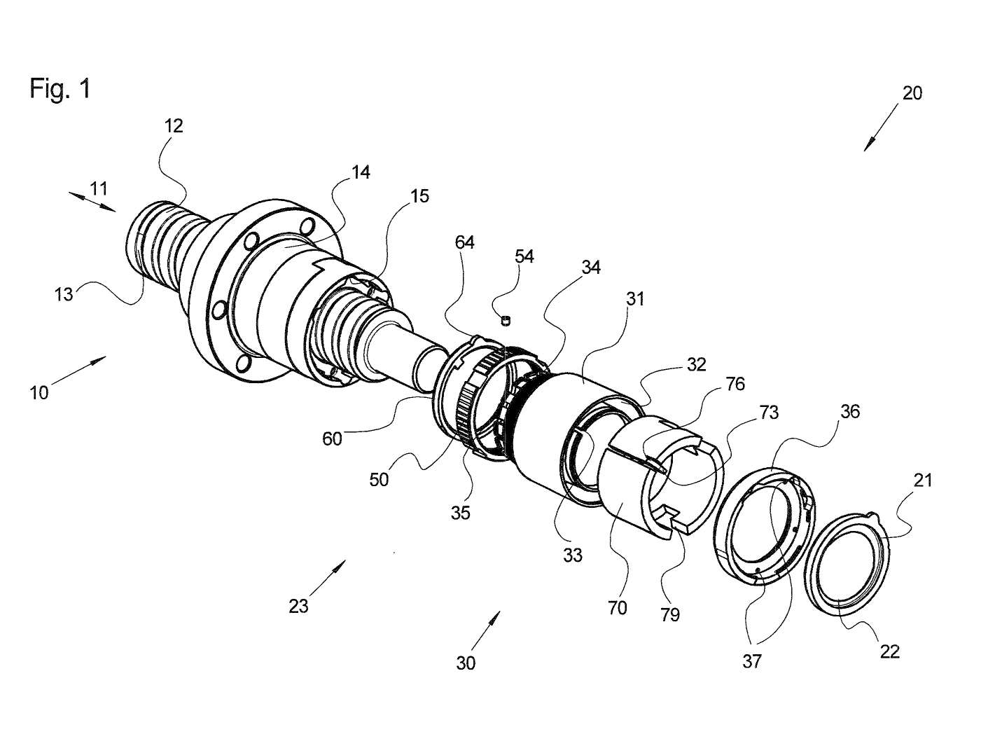

FIG. 1 shows a threaded drive unit 10 comprising a lubricating unit 20 according to the invention. Threaded drive unit 10 comprises a spindle 12 which extends in longitudinal direction 11 and is provided with a helical threaded turn 13. A nut 14, specifically a reciprocating ball nut, is disposed around spindle 12, and is in threaded engagement with spindle 12. Lubricating unit 20 is installed on the front—as shown in FIG. 1—longitudinal end face of nut 14.

Lubricating unit 20 comprises a housing 30 composed of a base body 31 and a cover 36, both of which are manufactured of plastic using an injection-molding procedure. Base body 31 is substantially hollow-cylindrical in design. An annular cavity 32 is provided in the interior of base body 31, which is open toward the front longitudinal end face of base body 31. A storage slab 70 is disposed in cavity 32; storage slab 70 starts out as a flat slab and is bent to form a circular ring. Cavity 32 is closed substantially completely using cover 36 on the front longitudinal end face of base body 31. Cover 36 is connected to base body 31 in a bonded manner using ultrasonic welding.

A plurality of oil-filling openings 37 is provided in cover 36, through which lubricating oil can be filled into cavity 32 of base body 31 e.g. using a cannula. Once lubricating oil has been filled into cavity 32, oil-filling openings 37 are covered with separate seal 21, thereby preventing lubricant from escaping housing 30 through oil-filling openings 37. Seal 21 is provided with a sealing lip 22 which bears against spindle 12, thereby preventing foreign objects from entering the interior of threaded drive unit 10 and simultaneously preventing lubricant from emerging from the interior of the threaded drive unit 10.

An oil outlet opening 33 is provided on the inner circumferential surface of base body 31, via which a connection exists between cavity 32 and spindle 12. An elongate projection 73 of storage slab 70 is guided through oil outlet opening 33, thereby enabling it to contact threaded turn 13 of spindle 12. Elongate projection 73 is formed as a single piece with storage slab 70 and is bent by approximately 90°. Storage slab 70 is composed of an open-cell foam material, namely polyurethane, thereby ensuring that elongate projection 73 is sufficiently flexible to bend as stated.

The lubricating oil that was filled into cavity 32 through oil-inlet openings 37 is absorbed by storage slab 70 and transferred via elongate projection 73 to threaded turn 13 of spindle 12, thereby ensuring that threaded drive unit 10 is sufficiently lubricated. The intention is for the oil supply in lubricating unit 20 to suffice for the entire service life of threaded drive unit 10. Thus, the lubricating oil must be delivered to threaded turn 13 particularly slowly. The delivery rate is influenced decisively by the properties, e.g. the pore size, of the foam material. The slow delivery rate of the lubricating oil likewise causes the lubricating oil—which is filled into cavity 32 through oil-filling openings 37—to be absorbed very slowly by storage slab 70. To ensure that the oil-filling procedure can take place quickly, oil-filling recesses 79 are provided in storage slab 70, which are open toward oil-filling recesses 37. The lubricating oil is therefore filled through oil-filling openings 37 into the open space created by oil-filling recesses 79, which can take within a short period of time. From there, the lubricating oil is absorbed by storage slab 70 until it is fully saturated with lubricating oil. The procedure can take place easily during the inevitable storage period in the production process, and therefore no additional costs are incurred. Once storage slab 70 has absorbed the entire quantity of lubricating oil from oil-filling recesses 79, additional lubricating oil can be filled into oil-filling recesses 79, thereby ensuring that lubricating unit 20 is filled with the maximum possible quantity of lubricating oil. The volume of oil-filling recesses 79 is matched to the volume of storage slab 70 in a manner such that the maximum quantity of stored lubricating oil is obtained by filling lubricating unit 20 twice.

On the rear longitudinal end face of housing 30 opposite cover 36, fastening means 23 are provided that can be used to fasten housing 30 to nut 14. Fastening means 23 are designed as described in DE 10 2006 033 852 A1, the entire contents of which are hereby referenced and incorporated in the contents of the present application. Fastening means 23 comprise a slotted ring 60 which is snapped into nut 14. A radial projection 64 is provided on ring 60, which engages in a matching recess 15 in nut 14, thereby preventing ring 60 from rotating relative to nut 14. A large number of hooks 35, which are designed as a single piece with base body 31 of housing 30, engage on the inner circumference of ring 60. Base body 31 is clamped with nut 14 via clamping nut 50 which is screwed onto base body 31. A threaded pin 54 is used to secure the rotary position of clamping nut 50.

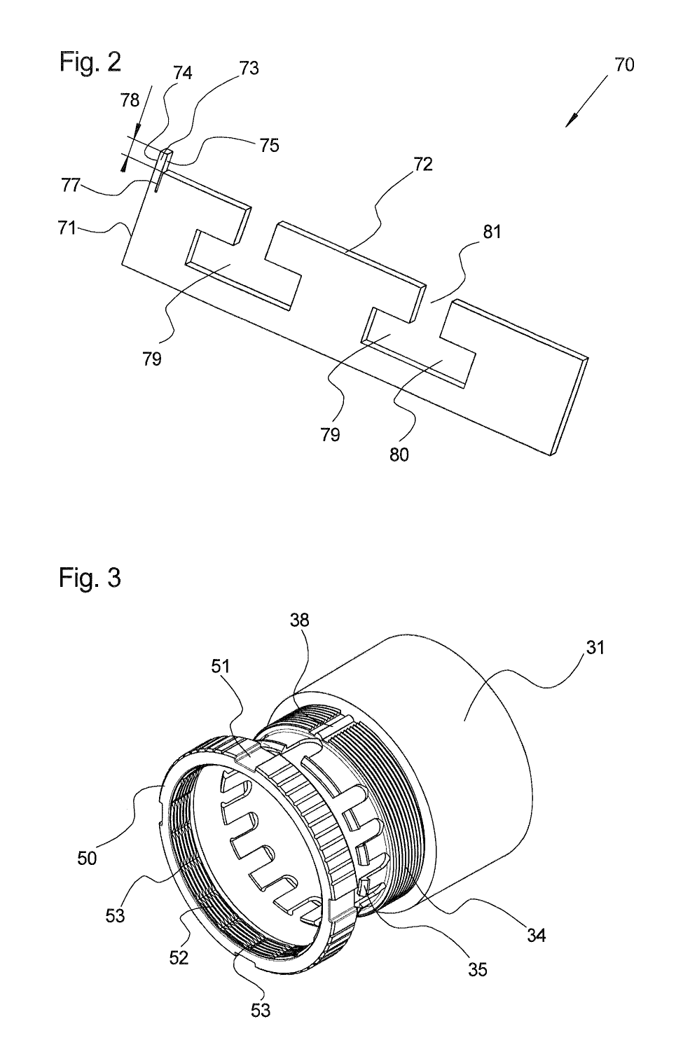

FIG. 2 shows storage slab 70 in the non-bent, flat state. In this state, storage slab 70 is cut out of a flat foam plate using water-jet cutting, wherein the storage slab can be inserted into the cavity (number 32 in FIG. 1) of the housing after the water-jet cutting and without any further reworking. Storage slab 70 has a substantially rectangular outline. An elongate projection 73 is provided on a corner of storage slab 70, which extends parallel to the longitudinal direction (number 11 in FIG. 1) of the spindle. First lateral surface 74 of elongate projection 73 is disposed as an extension of one short lateral surface 71 of storage slab 70, forming a flat, rectangular surface therewith. Elongate extension 73 has an overhang 78 beyond the outline of storage slab 70. Moreover, it is limited by a slot 77 which is disposed in extension of second lateral surface 75 of projection 73, wherein second lateral surface 75 of projection 73 extends parallel to first lateral surface 74. The bend (number 76 in FIG. 1) of elongate projection 73 is disposed in the region of the slot.

A total of two identical oil-filling recesses 79 are provided on long lateral surface 72 of storage slab 70 which is assigned to elongate projection 73. Oil-filling recesses 79 are designed in the shape of a “T” and have a narrow region 81, which is opposite the oil-filling openings (number 37 in FIG. 1), and a wide region 80 which provides the largest portion of the oil-storage volume.

FIG. 3 shows a second embodiment of base body 31 of housing 30 and clamping nut 50, wherein only the rotation lock of clamping nut 50 has been modified relative to the first embodiment. A fixing projection 38 is provided in the region of external thread 34 on base body 31, and extends slightly beyond the threaded turn of external thread 34. External thread 34, which is designed as a fine-pitch thread, is interrupted in the region of fixing projection 38. A large number of recesses 53 is provided in internal thread 52 of clamping nut 50, which extend parallel to fixing projection 38, thereby enabling the fixing projection to snap into recesses 53. The height of the fixing projection is selected such that internal thread 52 on clamping nut 50 is not damaged when it is screwed onto assigned external thread 34. In this case, the great elasticity of the plastic material of which base body 31 and clamping nut 50 are composed is utilized, in particular. This locked-in position prevents clamping nut 50 from accidentally coming loose. Reference is also made to grooves 51 on the outer circumferential surface of clamping nut 50, which are used to engage with a screwdriver tool, in particular a hook wrench.

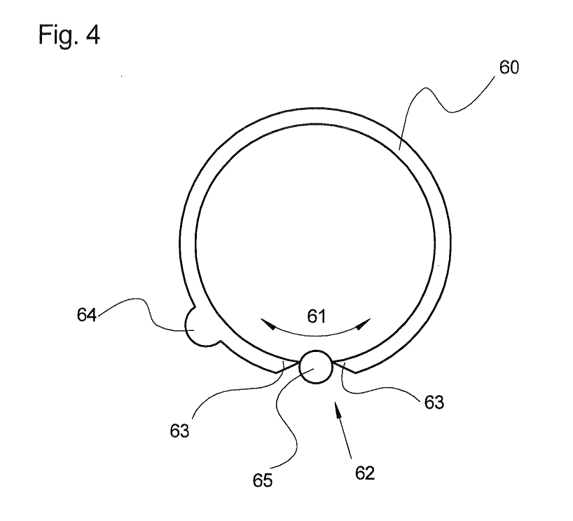

FIG. 4 shows ring 60 which is provided with an opening 62. Opening 62 causes ring 60 to be compressed radially inwardly in an elastic manner, thereby enabling it to be snapped into nut 14. To prevent ring 60 from accidentally becoming compressed, a locking body 65 in the form of a steel ball is inserted into opening 62 under load. Ends 63 of the ring are slanted in design and extend toward one another substantially in a pointed manner, thereby enabling the ball to be snapped into position behind the tips, where it is held.

It will be understood that each of the elements described above, or two or more together, may also find a useful application in other types of constructions differing from the types described above.

While the invention has been illustrated and described as embodied in a lubricating unit for a threaded drive unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### LIST OF REFERENCE CHARACTERS

10 Threaded unit drive
11 Longitudinal direction
12 Spindle
13 Threaded turn
14 Nut
15 Recess
20 Lubricating unit
21 Seal
22 Sealing lip
23 Fastening means
30 Housing
31 Base body
32 Cavity
33 Oil-outlet opening
34 External thread
35 Hook
36 Cover
37 Oil-inlet opening
38 Fixing projection
50 Clamping nut
51 Groove
52 Internal thread
53 Recess
54 Threaded pin
60 Ring
61 Circumferential direction
62 Opening
63 End
64 Radial projection
65 Locking body
70 Storage slab
71 Short lateral surface
72 Long lateral surface
73 Elongate projection
74 First lateral surface
75 Second lateral surface
76 Bend
77 Slot
78 Overhang
79 Oil-filling recess
80 Wide region
81 Narrow region

1. A lubricating unit (20) for use with a threaded unit drive (10), composed of a spindle (12) extending in a longitudinal direction (11) and a nut (14) enclosing the spindle (12), the lubricating unit (20) comprising:
a hollow-cylindrical housing (30) having a base body (31) with an annular cavity (32) that is closed on an end face using a separate cover (36);
a storage slab (70) composed of foam material accommodated in the cavity (32), wherein said storage slab (70) is bent to form a ring;
at least one oil-filling recess (79) extending through the storage slab (70);
fastening means (23) provided on a longitudinal end face of the housing (30) opposite the cover (36), wherein said fastening means are configured to fasten the housing (30) to the nut (14),
wherein the cover (36) is connected in an adhesive manner to the base body (31), and wherein the housing (30) has at least one oil-filling opening (37) open toward the oil-filling recess (79).

2. The lubricating unit according to claim 1, wherein the oil-filling opening (37) is provided in the cover (36), wherein the oil-filling recess (79) is open toward the edge (72) of the storage slab (70) facing the cover.

3. The lubricating unit according to claim 1, wherein the oil-filling recess (79) is designed substantially in the shape of a T.

4. The lubricating unit according to claim 1, wherein the storage slab (70) is substantially rectangular, wherein the storage slab (70) has an elongate extension (73) extending beyond an outline of the storage slab (70), wherein the elongate extension (73) and storage slab (70) have equal thicknesses, the elongate extension being bent by approximately 90°, thereby enabling said elongate extension (73) to contact a thread turn (13) of the spindle (12).

5. The lubricating unit according to claim 4, wherein at least one slot (77) extends through the storage slab (70), wherein said at least one slot (77) is disposed as an extension of the elongate projection (73), said elongate projection (73) including a bend (76), and wherein the bend (76) of the elongate projection (73) is disposed in a region of the at least one slot (77).

6. The lubricating unit according to claim 1, further comprising a clamping nut (50) having an internal thread (52) and fixing projection (38) provided on the housing (30), wherein the fastening means (23) include an external thread (34) on the housing (30), wherein said clamping nut (50) with said internal thread (52) is configured to be screwed onto said fastening means, wherein said fixing projection is adapted to engage in a plurality of recesses (53) provided in the clamping nut (50).

7. The lubricating unit according to claim 6, wherein the recesses (53) are elongate, are oriented in the longitudinal direction (11), and intersect the internal thread (52) of the clamping nut (50).

8. The lubricating unit according to claim 1, further comprising a ring (6) provided with an opening (60), wherein the fastening means (23) comprise a plurality of hooks (35) adapted to engage in the ring (60), wherein a locking body (65) is disposed in the region of the opening (62) in such a manner that a width of the opening (62) cannot be substantially reduced in a circumferential direction (61) of the ring (60).

9. The lubricating unit according to claim 8, wherein the locking body (65) is a ball.

10. The lubricating unit according to claim 8, wherein the ring (60) is provided with a radial projection (64) adapted to engage in a corresponding recess (15) in the nut (14).
